(19) United States
(12) Patent Application Publication
(10) Pub. No.: US 2023/0232863 A1
(43) Pub. Date: Jul. 27, 2023

(54) FEED COMPOSITION FOR TENEBRIO MOLITOR

(71) Applicants: Taehyuk Shon, Seoul (KR); Jimin Shon, Seoul (KR)

(72) Inventors: Taehyuk Shon, Seoul (KR); Jimin Shon, Seoul (KR)

(21) Appl. No.: 17/584,614

(22) Filed: Jan. 26, 2022

(30) Foreign Application Priority Data
Jan. 24, 2022 (KR) 10-2022-0010299

(51) Int. Cl. A23K 20/147; A23K 50/90; A23K 10/20

(52) U.S. Cl. CPC A23K 20/147; A23K 50/90; A23K 10/20

(57) ABSTRACT

According to an aspect, there is provided a feed composition for Tenebrio molitor, comprising water, gelatin and alloferon peptide as effective components. The alloferon peptide is preferably included 1 ppm or more in the feed composition. The alloferon peptide can act as a growth promotor for Tenebrio molitor. Also, the alloferon peptide can act to enhance the survival rate of Tenebrio molitor. Also, the alloferon peptide can act to shorten the development time of Tenebrio molitor.

### CROSS-REFERENCE TO RELATED APPLICATION

This application claims priority to Korean Patent Application No. 10-2022-0010299 filed on Jan. 24, 2022, the entire contents of which are herein incorporated by reference.

### TECHNICAL FIELD

The present disclosure relates to a feed composition for Tenebrio molitor.

### BACKGROUND

At least 690 million people around the world suffered from hunger and nutrient deficiencies at 2019 according to a recent report of Food and Agriculture Organization (FAO) of the United Nations. The constant increase in world population raises serious questions regarding our capacity to provide an adequate food source. Another study reported that the world's population is expected to reach or exceed 9.6 billion by 2050 and global demand for food is expected to grow by 70%.

Moreover, the ongoing human-driven encroachment on the environment mainly due to the demands for urbanization and food production exacerbates the imminent crisis. For example, livestock/meat production plays an important role in climate change, with emissions estimated at 7.1 gigatonne CO₂-eq per annum, representing 14.5 percent of human-induced greenhouse gas emissions. It also occupies 26 percent of the ice-free terrestrial surface of the planet as well as 70 percent of all agricultural land, and leaves negative effects behind on the grazed land, such as deforestation, terrain compaction and erosion. To sum up, the increasing demand for food, especially animal-based protein is adversely impacting the environment in terms of greenhouse gas emissions, water, energy, and land usage.

As a solution for these problems, insects are considered to have the potential to be a new, environment-friendly food source. The culture of entomophagy, in fact, has been around for hundreds of years. While European populations and European-derived populations in North America historically have placed taboos on entomophagous eating practices, native cultures in Asia, South America, Africa, and Europe include the consumption of various species of insects. Approximately 2.000 insect species are consumed in at least 113 countries presently. Insects are food sources with a low environmental impact due to the limited need for arable land and water, compared with livestock, and low ecological cost. Besides, the insects can provide the nutritional benefits such as high quality of proteins, polyunsaturated fatty acid, dietary fibers, and various micronutrients. Therefore, the concept of insect farming, the practice of raising and breeding insects as livestock mostly as a new food/protein source has been gradually developing and has become a reality over the past few years.

Mealworms (Tenebrio molitor) are the larval form of two darkling beetle species of the Tenebrionidae family, the yellow mealworm beetle and the dark or mini mealworm beetle. Tenebrio molitor, like all holometabolous insects, go through four growth stages: egg, larva, pupa, and adult, and the whole life cycle spans from 280 to 630 days. It takes 10-12 days for the larvae to hatch, matures in typically 3-4 months after a variable number of stages; a mature larva comes to be a light yellow-brown color, 20 to 32 mm long, weighing 130-160 mg. Then, they enter the pupal stage which lasts about 7-9 days at room temperature, and eventually become adult Tenebrio molitor, which live for 2 to 3 months. Mealworm's diet is not strictly limited, as they are omnivorous and can devour all kinds of plant materials as well as animal products. The advantages such as high protein content, well-balanced amino acid profile, efficient feed conversion rate, and available mass production technology made mealworms be considered as a promising candidate for insect rearing.

Alloferon (H-His-Gly-Val-Ser-Gly-His-Gly-Gln-His-Gly-Val-His-Gly-OH), group of naturally occurring immunomodulatory peptides is chiefly isolated from a hemolymph of bacteria challenged maggots of the blow fly Calliphora vicina. The challenged maggots create and accumulate in the hemolymph exceptionally increased levels of defense molecules regarding insect immune response. The most of the hemocytes presented with cytotoxic activity compared to the activity of mammalian natural killer cell, which is another unique property which is uncovered so far in other insects. Alloferon included in hemolymph was found to stimulate natural cytotoxicity of mouse spleen lymphocytes in vitro and human blood mononuclear cells. Synthetic alloferon administered in picomolar concentrations showed not only significant capability to increase natural cytotoxicity in the same mouse and human in vitro but antiviral and anti-tumor activities in mouse in vivo.

The other kinds of biological activity of alloferons were reported such as stimulation of interferon synthesis in mice and humans in vivo, suppression of herpes simplex virus in vitro proliferation, deblocking of nuclear factor kappa-light-chain-enhancer (NF-uB) mediated signaling pathway and modification of proinflammatory cytokines production.

Moreover, Natural killer cells demonstrated a similar effect as effector cells including cytotoxic activity related with therapeutic efficacy in the disease of recurrent genital herpes and are supposed to play a key role as the pharmacological target of alloferon.

To sum up the previous experimental and clinical studies, alloferon can be considered as an immunomodulatory peptide even though it is different from the noted immunotropic biologicals like cytokines, chemokines, interferons, therapeutic antibodies in its origin, molecular structure and mechanism of action. However, its potential effect on the growth performance and survival rate of mealworms is still unknown.

In the present study, we hypothesized that alloferon could enhance the immunity and viability of mealworms, as well as increase the growth rate and survival rate. Thus, this study aimed to evaluate the effect of alloferon on the growth performance and survival rate of mealworms, and to investigate the mechanism of alloferon. Moreover, the large-scale validation was performed to confirm the effect of the alloferon.

### SUMMARY

An object of the present disclosure is to evaluate the effect of alloferon on the growth performance and survival rate of Tenebrio molitor.

Also, an object of the present disclosure is to provide a feed composition for Tenebrio molitor, which highly enhances the growth performance and survival rate of mealworm in comparison with the conventional fee composition for mealworm.

According to an aspect, there is provided a feed composition for Tenebrio molitor, comprising water, gelatin and alloferon peptide as effective components. The Alloferon peptide is preferably included 1 ppm or more in the feed composition. The alloferon peptide acts as a growth promotor for Tenebrio molitor. Also, the alloferon peptide acts to enhance the survival rate of Tenebrio molitor. Also, the alloferon peptide acts to shorten the development time of Tenebrio molitor.

According to the present disclosure, the effect of alloferon on the growth performance and survival rate of Tenebrio molitor is evaluated.

Also, according to the present disclosure, there is provided a feed composition for Tenebrio molitor, which highly enhances the growth performance and survival rate of Tenebrio molitor in comparison with the conventional fee composition for Tenebrio molitor.

### BRIEF DESCRIPTION OF THE DRAWINGS

FIG. 1 shows a body weight of mealworms (T. Molitor) after gelatin and alloferon-containing gelatin diet.

FIGS. 2A and 2B show a survival rate and time required for larvae-pupae transformation of mealworm.

FIG. 3. shows a cell proliferation of Sf9 cells after 300 nM of the alloferon treatment.

FIG. 4 shows a test result, in which PO activity is analyzed in mealworm body tissue after alloferon treatment.

FIGS. 5A and 5B show a test result related to a large-scale mealworm production.

### DETAILED DESCRIPTION

In the following detailed description of the present disclosure, references are made to the accompanying drawings that show, by way of illustration, specific example embodiments in which the present disclosure may be practiced. These example embodiments are described in sufficient detail to enable those skilled in the art to practice the present disclosure. It is to be understood that the various example embodiments of the present disclosure, although different from each other, are not necessarily mutually exclusive. For example, specific shapes, structures and characteristics described herein may be implemented as modified from one example embodiment to another without departing from the spirit and scope of the present disclosure. Furthermore, it shall be understood that the positions or arrangements of individual elements within each of the example embodiments may also be modified without departing from the spirit and scope of the present disclosure. Therefore, the following detailed description is not to be taken in a limiting sense, and the scope of the present disclosure is to be taken as encompassing the scope of the appended claims and all equivalents thereof.

Hereinafter, various preferable example embodiments of the present disclosure will be described in detail with reference to the accompanying drawings to enable those skilled in the art to easily implement the present disclosure.

### <Materials and Methods>

### 1. Fabrication of Feeding Gelatin

The feeding gelatin was made with combining 200 g of distilled water and 4 g of paper gelatin (Gelita H G, Eberbach, Germany), and solidified in the refrigerator using an ice cubic stick tray with the lid closed. The same process was performed for the experimental group of gelatin containing alloferon peptide (Biomatik, Del., USA) of 1 ppm. The tray had 10 slots to make each gelatin of approximately 20 g gelatin cubic and kept in the refrigerator with the lids closed to minimize loss of moisture.

### 2. Mealworms Larvae Feeding

Yellow mealworms (Tenebrio molitor) were provided by a private local insect breeder (Mealworm village, Seoul, Korea). Mealworms larvae were divided into three different dietary groups: (1) About 500 larvae were placed in a plastic container (18.5×12×5.5 cm) with 30 g wheat bran only (control group), (2) About 500 larvae with wheat bran supplemented with 20 g gelatin three times per week (positive control group), (3) About 500 larvae with wheat bran supplemented with 20 g gelatin containing alloferon peptide of 1 ppm three times per week (experimental group).

Two replicated containers per each dietary group were set up, after which the containers were placed in a climate chamber at 25° C. with a relative humidity of 60%.

In addition, the assessment of developmental time with large-scale was performed to confirm the result from the former laboratory-scale experiment. For the experimental group, 15,000 larvae with wheat bran supplemented with gelatin containing 10 ppm alloferon were prepared similar with lab-scale feeding protocol. For the control group, the same amount of larvae was fed with wheat bran only until larvae-pupae transformation.

### 3. Mealworms Larvae Growth, Survival Rate and Development (Larvae-Pupae Transformation) Analysis

Mealworms pupae and dead larvae were counted and removed daily from each experimental group, and the numbers were recorded for the evaluation of survival rate. The average weight of the mealworm larvae was recorded every week with 20 randomly selected mealworms.

Development time of mealworms was considered to be the number of days until 50% of mealworms larvae changed into pupae stage.

For various analysis of biologic response, harvested mealworms larvae were killed by freezing and then all mealworms stored at −20° C.

### 4. Phenoloxidase Activity Analysis

Penoloxidase activity in homogenized larvae tissue was analyzed with a 96 well microplate reader using catechol as the substrate. After the sample was incubated for 37° C. for 10 min, the 420 nm absorbance was measured with a microplate spectrophotometer (Bio-Rad, CA, USA). The essay was performed with three replicates and each experiment was repeated three times. The penoloxidase activity was expressed as units of enzyme activity per mg protein.

### 5. In Vitro Cell Proliferation Analysis by PrestoBlue Assay

The proliferation of Sf9 insect cells was analyzed by the PrestoBlue assay (Invitrogen, CA, USA). 8,000 cells/well were prepared in 96 well plates (Sigma-Aldrich, MI, USA). After cells were seeded, the cells were incubated with PBS with alloferon (300 nM). The control group received PBS without aloferon. At 0, 2, 4, and 6 days after applying 10% PrestoBlue, the color switchover of resazurin to resorufin (Absorbance 570 nm/600 nm) was measured with the microplate reader (BioTeck, Vt., USA).

### 6. Large-Scale Validation of Mealworms Larvae Development Time (Larvae-Pupae Transformation)

The assessment of developmental time with large-scale was performed using the same method with the former laboratory-scale experiment. The time point at which the total weight of the mealworms in each feeding tray reached 3 kg was set as the development time.

### 7. Statistical Test

Unpaired t-test was used for all statistical analysis using GraphPad Prism 8 (GraphPad, CA, USA). Statistical significance was set at p<0.05.

### <Results>

### 1. Effect of the Gelatin and Alloferon-Containing Gelatin Diet on Body Weight of the Mealworms (T. Molitor).

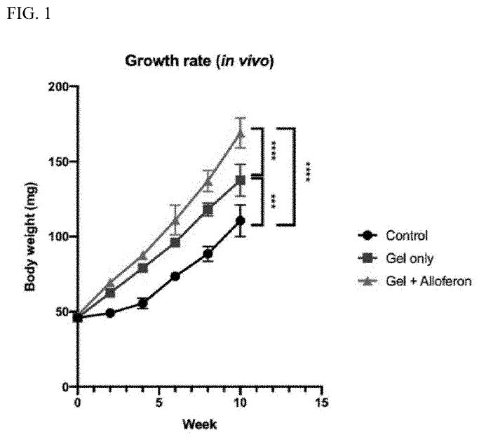

For the three groups of mealworms, average weight of wheat bran diet group increased 140.2% over 10 weeks. Gelatin diet supplementation group improved the growth rate to 189.4% and Alloferon-containing gelatin supplementation group improved the growth rate to 267.3% (FIG. 1). In week 10, mealworms larvae fed on gelatin and alloferon supplement were 39.5%-90% heavier than those fed on wheat bran only (p<0.05).

(A) Gelatin contained with allfoeron supplement was provided to the mealworms (T. Molitor). (B) Effect of gelatin and alloferon-containing gelatin on body weight change of mealworms was analyzed over 10 weeks of larvae development. (C) Body weight of mealworms was increased after gelatin and alloferon-containing gelatin diet. Duplicate samples were analyzed in each condition. Two-way ANOVA with Tukey multiple comparisons test was used to analyze the statistical significance; p<0.001(***) and p<0.0001(****).

### 2. Effect of the Gelatin and Alloferon-Containing Gelatin Diet on Survival Rate and Development Time (Larvae-Pupae Transformation) of the Mealworms (T. Molitor).

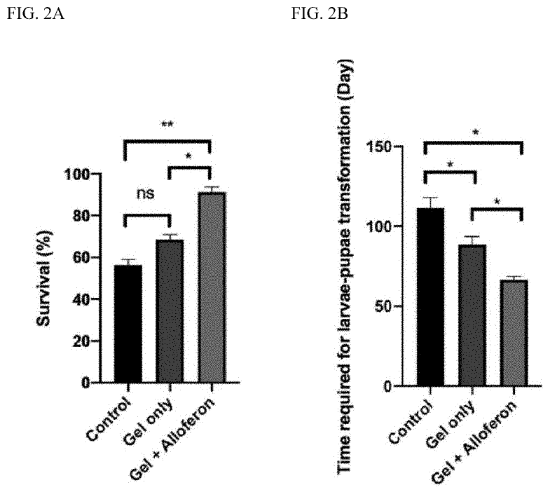

The average survival rates of pupated mealworms fed on wheat bran diet, gelatin and alloferon-containing supplement diet were 56.4%, 68.5% and 91.3% respectively (FIG. 2A).

In this study, mealworms larvae transformed into pupae in 9 to 17 weeks. Development time was defined as the number of days until 50% of mealworm larvae changed into pupae stage. The development time of mealworms in the experimental group was shortened up to 20.6%-39.6% on gelatin and alloferon-containing gelatin diet compared to the control group with wheat bran diet.

(A) Survival rate of mealworms fed on wheat bran, gelatin supplement and alloferon-containing gelatin. (B) Development time of mealworms fed on wheat bran, gelatin supplement and alloferon-containing gelatin. Duplicate samples were analyzed in each condition. Unpaired t-test was used to analyze the statistical significance; p>0.05 (ns) and p<0.05 (*).

### 3. Effect of the Alloferon Treatment on Sf9 Insect Cell Proliferation.

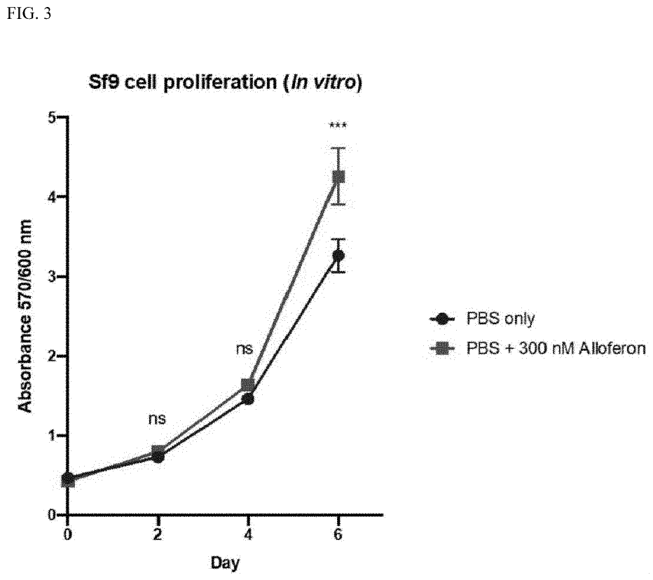

To test whether alloferon treatment increases cell proliferation in insect cell, in vitro proliferation assay was performed on Sf9 insect cell. Sf9, which is originally established from ovarian tissue, is commonly used in insect cell culture for in vitro assay. Presto blue assay reveals that 300 nM alloferon significantly boosted cell proliferation of Sf9 cells only after 6 days of the treatment (FIG. 3). This result suggests that alloferon increase insect cell proliferation. Triplicate samples were analyzed in this assay. Two-way ANOVA with Tukey multiple comparisons test was used to analyze the statistical significance; p>0.01(ns) and p<0.01(***).

4. Effect of the Alloferon Diet on Phenoloxidase Activity in Mealworms (T. molitor) Tissue.

FIG. 4 shows a test result, in which PO activity is analyzed in mealworm body tissue after alloferon treatment. Duplicate samples were analyzed in this assay. Unpaired t-test was used to analyze the statistical significance; p<0.05 (*).

### 5. Validation of the Alloferon Diet on Shortening Development Time (Larvae-Pupae Transformation) of the Mealworms (T. Molitor) in Large-Scale Insect Farming

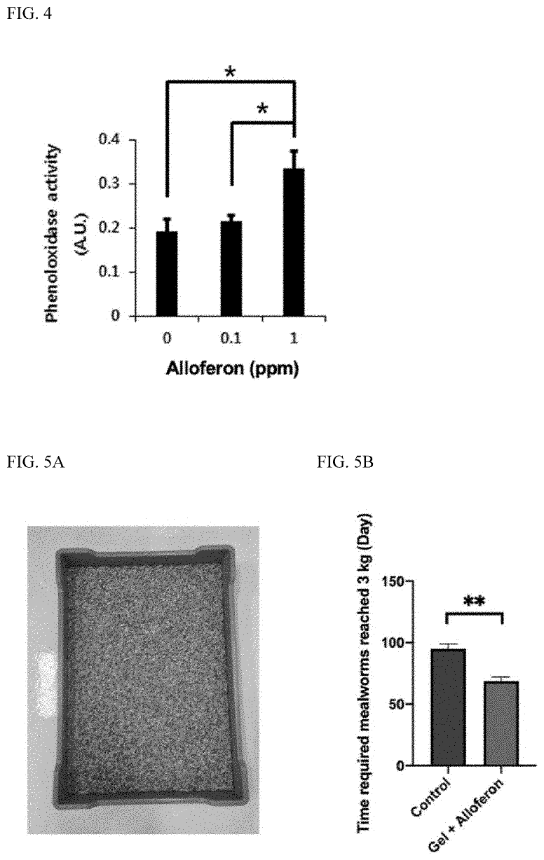

To confirm the effect of alloferon enhancing the growth rate of mealworms, large-scale experiment was performed with ˜15,000 mealworms (FIG. 5A). In this large-scale experiment, the development time of mealworms required to reach 3 kg in weight (n=15,000) was analyzed. The development time of the 1 ppm alloferon gelatin diet group significantly shortened up to 28.7% compared to the control group with wheat bran diet group (FIG. 5B). Unpaired t-test was used to analyze the statistical significance; p<0.01 (**).

Considering world population increases, food shortages, and environmental pollution, the insect proteins are expected as a favorable alternative. The edible insects have nutritional advantages because it is composed of high protein (50-60%), considerable amount of fat, fiber, vitamins, and minerals. Mealworms (Tenebrio molitor) used in this study are also known to contain a substantial amount of protein and unsaturated fatty acid. While the attempt for developing and applying mealworms for protein supply to patient diet has been continued, a recent study reported that mealworm diet not only increased the muscle mass and body fat, but also activated the immune cells in cancer patients. The nutrient contents of mealworms are considered valuable as a good source of nutrition for patients who need high nourishment even if with small amounts.

The antibacterial effects of alloferon on mealworms have been reported in the previous study. In particular, the correlation with the increased activity of the penoloxidase and the innate immunity of insects was evaluated. The present study is the first up to our knowledge to evaluate that alloferon shortened development time as well as increased survival rate of mealworms by increasing the expression of penoloxidase. This result suggested the possibility of application of alloferon to invertebrates including other insects. The study of Bai P P et al. supported our study that penoloxidase played an important role in melanin production, which is related in invertebrate immune mechanism and insect development process [Bai P P, Xie Y F, Shen G M, Wei D D, Wang J J. Phenoloxidase and its zymogen are required for the larval-pulpal transition in Bactrocera dorsalis (Diptera: Tephritidae). J Insect Physiol 2014; 71:137-4625].

Mealworms can be fed on wheat bran to obtain all required nutrients for growth, development, and reproduction. The previous studies showed that larval survival could be improved when additional ingredients were provided. However, most of the studies have focused on balance and replenishment of macronutrients including protein, fat, and starch. The present study is comparable with other studies in that it suggested a biological mechanism rather than a nutritional method for promoting mealworm growth. Large-scale feeding showed the parallel developmental time compared to the laboratory-scale.

In order to prevent cannibalism and increase productivity in mealworm breeding, sufficient moisture supply is an important factor. Previously, supplements such as vegetables and fruits were mainly used for hydration. In this study, growth disturbance was not detected when moisture supply was provided with a gelatin containing alloferon peptide without any conventional supplements such as vegetables. This might be attributable to the composition of gelatin containing hydrolyzed collagen peptide and water. Thus, it is expected that this type of gelatin might be applied to the insect farming industry as vehicles to supply hydrophilic peptide, alloferon and moisture simultaneously.

This study showed alloferon peptide of 1 ppm composed of 16 amino acid decreased the development time of mealworms by 40.3% and increased survival rate over 61.8% (FIGS. 1, 2A, and 2B). This result can be applicable for the increase of productivity required from a large-scale smart insect farming system, and used as an important basis for providing economic value to the insect production industry. As a conclusion, alloferon promoted the growth performance of mealworms as reducing the development time and survival rate, and it might lead to a favorable solution for the insect breeding industry. The effect of alloferon was confirmed in the large-scale feeding.

What is claimed is:

1. A feed composition for Tenebrio molitor comprising water, gelatin and alloferon peptide as effective components.

2. A feed composition for Tenebrio molitor of claim 1, wherein the alloferon peptide is included in 1 ppm or more in the feed composition.

3. A feed composition for Tenebrio molitor of claim 2, wherein the alloferon peptide acts as a growth promotor for Tenebrio molitor.

4. A feed composition for Tenebrio molitor of claim 2, wherein the alloferon peptide enhances the survival rate of Tenebrio molitor.

5. A feed composition for Tenebrio molitor of claim 2, wherein the alloferon peptide shortens the development time of Tenebrio molitor.
